(19) United States
(12) Patent Application Publication
(10) Pub. No.: US 2013/0159979 A1
(43) Pub. Date: Jun. 20, 2013

(54) APPARATUS AND METHOD FOR PERFORMING EMULATION ON ROBOTIC APPLICATION

(71) Applicant: Electronics and Telecommunications Research In, Daejeon (KR)

(72) Inventors: Seung-Ik LEE, Daejeon (KR); Rockwon KIM, Daejeon (KR); Choulsoo JANG, Daejeon (KR); Seung-Woog JUNG, Daejeon (KR); Byoung Youl SONG, Daejeon (KR); Sung Hoon KIM, Daejeon (KR)

(73) Assignee: Electronics and Telecommunications Research Institute, Daejeon (KR)

(21) Appl. No.: 13/677,747

(22) Filed: Nov. 15, 2012

(30) Foreign Application Priority Data
Dec. 14, 2011 (KR) 10-2011-0134286

(51) Int. Cl. G06F 11/36

(52) U.S. Cl. CPC G06F 11/3664
USPC 717/134

(57) ABSTRACT

An apparatus for performing emulation on a robotic application includes an emulation unit configured to perform emulation on a symbol and function corresponding to a control command of a robotic application. Further, the apparatus includes a robot unit configured to register the symbol and function to the emulation unit, and control a device of a robot; and a robotic application control unit configured to control the symbol and function of at least one robot by executing the robotic application.

### CROSS-REFERENCE TO RELATED APPLICATION(S)

The present invention claims priority of Korean Patent Application No. 10-2011-0134286, filed on Dec. 14, 2011, which is incorporated herein by reference.

### FIELD OF THE INVENTION

The present invention relates to robotic emulation technology for debugging and testing robotic applications in a distributed environment; more particularly, to an apparatus and method for performing an emulation on a robotic application suitable for virtually executing a symbol value or function, instead of obtaining or performing a particular symbol or function directly from the robot.

### BACKGROUND OF THE INVENTION

The robot is a platform having many hardware devices. Based on this platform, the robots are controlled and applications are created for providing useful services for users. These robotic applications are typically operated through a sequence of sensing, perception, decision-making, and actions. The robotic applications have many other features different from the conventional computer applications operated only on a computer because the robotic applications have sensing and acting part which are responsible for interacting with the outside in the processing.

Therefore, unlike a number of common computer applications, the development of robotic applications is achieved by the process of numerous trials and errors. Unlike the computer, as the robot interacts with dynamically changing real world and the user by using various sensors and actuators, predicting all the circumstances of the relationship is required to write robotics applications.

As described above, the development of robotic applications in conventional techniques needs a process repeated many times by mounting a developed application on a robot, checking the malfunction, and modifying the application.

However, the method needs to mount the application directly on the robot, and reproduce an error situation in the real world to find the cause of the error, so the test has some problems that require a considerable amount of time and hard work.

### SUMMARY OF THE INVENTION

In view of the above, the present invention provides an apparatus and a method for performing an emulation on a robotic application, which are capable of, when necessary, allowing the symbol value or function virtually to be performed in testing and debugging of the application, without obtaining certain symbols or performing functions directly from a robot.

Further, the present invention provides the apparatus and method for performing the emulation on the robotic application, which are capable of transmitting the set symbol value or functional to the robotic applications when receiving control commands for performing a particular symbol or function from robotics applications while a particular symbol or function of a robot is set to the emulation mode in the emulation unit.

In accordance with a first aspect of the present invention, there is provided an apparatus for performing emulation on a robotic application includes an emulation unit configured to perform emulation on a symbol and function corresponding to a control command of a robotic application; a robot unit configured to register the symbol and function to the emulation unit, and control a device of a robot; and a robotic application control unit configured to control the symbol and function of at least one robot by executing the robotic application.

In accordance with a second aspect of the present invention, there is provided a method for performing emulation on a robotic application including: registering a symbol and a function received from a robot unit to the emulation unit; when a control command is received from the robotic application executed in a robotic application control unit, performing the emulation on the symbol and the function corresponding to the control command; and transmitting the emulation value to the robotic application control unit.

In accordance with an embodiment of the present invention, it is possible to easily perform testing and debugging of the robotic application, if necessary, by virtually performing a certain symbol or function without obtaining the symbol value or function directly from the robot.

As a result, there is no need to employ the robotic application in the robot, to reproduce an error situation in a real world. Further, execution may be easily performed step by step like a debugging in general computer programming. Furthermore, time and hard work for the testing may be considerably reduced, thereby increasing the efficiency and productivity.

### BRIEF DESCRIPTION OF THE DRAWINGS

The objects and features of the present invention will become apparent from the following description of embodiments given in conjunction with the accompanying drawings, in which:

FIG. 1 is a block diagram showing the configuration of an apparatus for performing emulation on a robotic application in accordance with an embodiment of the present invention;

FIG. 2 is a flow chart showing the operating procedures of the apparatus for performing emulation on the robotic application in accordance with the embodiment of the present invention;

FIG. 3 is a block diagram showing the configuration of an emulation unit shown in FIG. 1;

FIG. 4 is a block diagram showing the configuration of a generating unit included in each symbol and function shown in FIG. 3; and

FIG. 5 is a block diagram showing the configuration of a robot unit shown in FIG. 1.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described in detail with reference to the accompanying drawings which form a part hereof.

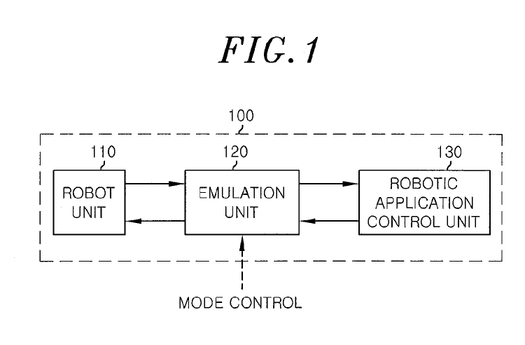

FIG. 1 is a block diagram showing the configuration of an apparatus for performing emulation on a robotic application in accordance with an embodiment of the present invention.

Referring to FIG. 1, the apparatus 100 for performing emulation on the robotic application may include robot unit 110, emulation unit 120, and robotics applications control unit 130, and the like, and the apparatus may be employed on a computer or robot, or may be employed on separate computers or robots.

Specifically the robot unit 110 may perform the control and function for a robot, register and delete multiple symbols and functions to/from the emulation unit 120, and may perform the symbols and functions by controlling the robot.

In other words, the robot unit 110 may register the symbol and function of the robot when interworking with the emulation unit 120, or may register and/or delete the symbols and functions to/from the emulation unit 120 when receiving a request from the emulation unit 120.

The emulation unit 120 may perform emulation on the robotics applications, register the plurality of symbols and functions received from the robot unit 110, and set an execution mode for each symbol and function. At this time, the emulation unit 120 may be included in the apparatus 100 the robotics applications and an execution mode setting command (e.g. real-mode, emulation mode and the mode-setting and the lime) may be received from a user through a touch panel or an interface (not shown) included in the emulation unit 120.

In other words, symbols or functions have a real-mode interworking with the robot unit 110 and an emulation-mode sending a emulated value to the robotic application control unit 130 without interworking with the robot unit 110. The setting command of an execution mode (real-mode or emulation mode) for a particular symbol or function is input from the user, and the real-mode may be set if the setting command of the execution mode is not input.

The emulation unit 120 may set the emulation mode for the pre-registered symbols or functions and values thereof based on the setting command of the execution mode input from the user.

The robotic application control unit 130 may include at least one robotics applications performing the application logic for the robot. Further, if particular robotics applications are executed, an execution request of at least one of a symbol or function may be transmitted to the emulation unit 120.

Accordingly, a robotics application executed in the robotics applications control unit 130 may control one or more robots by accessing the emulation unit 120 to refer to the symbol or the function registered by the robot to be controlled.

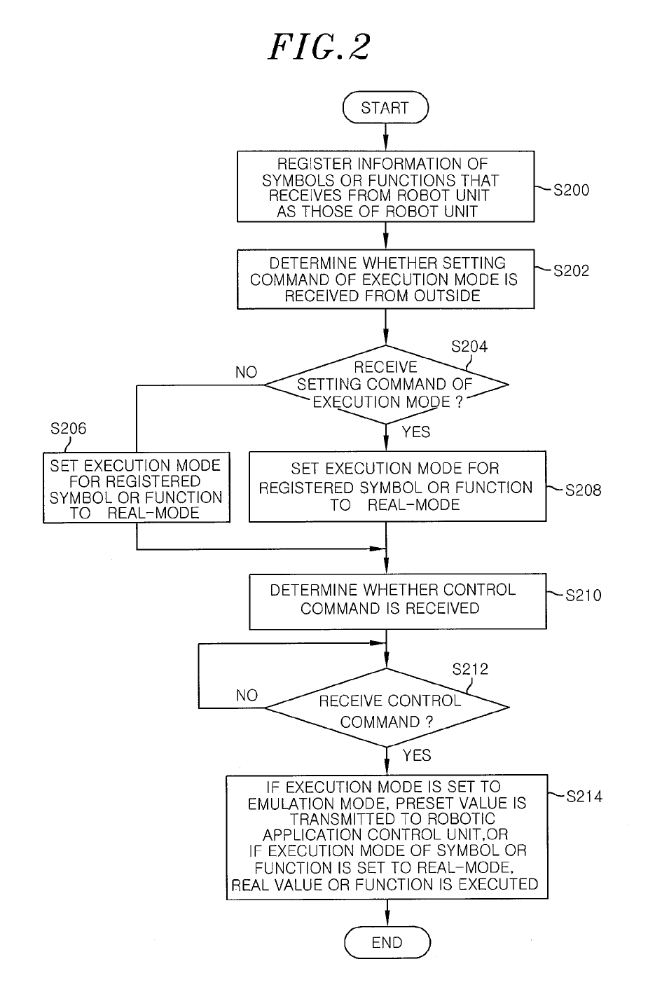

FIG. 2 is a flow chart showing the operating procedures of the apparatus for performing emulation on the robotic application shown in FIG. 1.

Referring to FIG. 2, in step S200, the robot unit 110 of the apparatus 100 for performing emulation on the robotic application transmits information of the symbols or functions that the robot have to request registration of the symbols or the functions to the emulation unit 120. The emulation unit 120 registers the received information of the symbols or functions as those of the robot unit 110.

In step S202, the emulation unit 120 determines whether the setting command of the execution mode is received from outside, i.e., the user. In step S204, if it is determined that the setting command of the execution mode is not received for a preset period of time, a control step proceeds to step S206, the emulation unit 120 sets the execution mode for the registered symbol or function to the real-mode.

On the other hand, if it is determined that the setting command of the execution mode is received in step S204, the control step proceeds to step S208, and the emulation unit 120 sets the execution mode for the symbol or function included in the setting command for the execution mode to the emulation mode.

Further, if the robotic application is executed in the robotic application control unit 130, the executed robotic application sends a control command to the robot unit 110 using a preset control method by referring to the various symbols or functions in the emulation unit 120.

In step S210, the robotic application control unit 130 transmits the control command for a symbol or function of the executed robotic application to the emulation unit 120, and the emulation unit 120 determines whether the control command is received.

If it is determined that the control command is received in step S212, a control step proceeds to step S214 and the emulation unit 120 checks the execution mode of the symbol or function included in the control command based on the pre-registered symbol or function. As a result of the check in step S214, if the execution mode is set to the emulation mode, a preset value, i.e., a virtual value is transmitted to the robotic application control unit 130 without interlocking with the robot unit 110. On the other hand, if the execution mode of the symbol or function is set to the real-mode, the control command is transmitted to the robot unit 110 by interworking with the robot unit 110, so that the real value or real function corresponding to each symbol or function is executed in the robot unit 110.

For example, in the robot A in which the robot unit 110 is employed, the symbol indicating the presence or absence of obstacles (A.obstacle), straight function (A.forward), left turn function (A.turn_left), and right turn function (A.turn_right) is registered in the emulation unit 120. The user of outside sets the emulation mode to the symbol (A.obstacle) registered in the emulation unit 120 through the setting command of the execution mode. Further, a range as relevant parameter is set to the enumeration range having, e.g. 0 or 1, and the distribution is set to a single distribution having, e.g., the probability of 0.5 for each of 0 and 1. It is assumed that the robotic application executed by the robotic application control unit 130 sets the emulation mode to the symbol (A.obstacle).

To control the robot A, the executed robotic application determines whether to perform going straight or turn left or right by referring to the symbol value of (A.obstacle). At this time, because the symbol (A.obstacle) is set to the emulation mode, the robotic application receives an emulated value from the emulation unit 120, not an actual value obtained by interworking with the robot unit 110.

In other words, when the robotic application control unit 130 transmits the control command for the symbol (A.obstacle) to the emulation 120, the emulation unit 120 checks the execution mode of the symbol (A.obstacle). As a result of the check, if the execution mode is set to the emulation mode, the emulated value is transmitted to the robot application control unit 130 depending on the preset range and distribution.

If the emulation unit 120 sends the emulation value that there is an obstacle to the symbol (A.obstacle), the executed robotic application calls A.turn_left or A.turn_right function to avoid the obstacle. This call is transmitted back to the emulation unit 120, the emulation unit 120 transmits the call to the robot unit 110, and thus the function is really executed in the robot.

At this time, if the emulation mode do not exist, in order to test the logic of the robotic application, the circumstances such as the obstacle really exists and do not exist are implemented, and then the robot application needs to be tested under the circumstances. Accordingly, burdensome and time-consuming disadvantage described above may be overcome by the emulation mode. Moreover, the robotic application may be successfully executed by turning off the emulation mode after completing testing and debugging process.

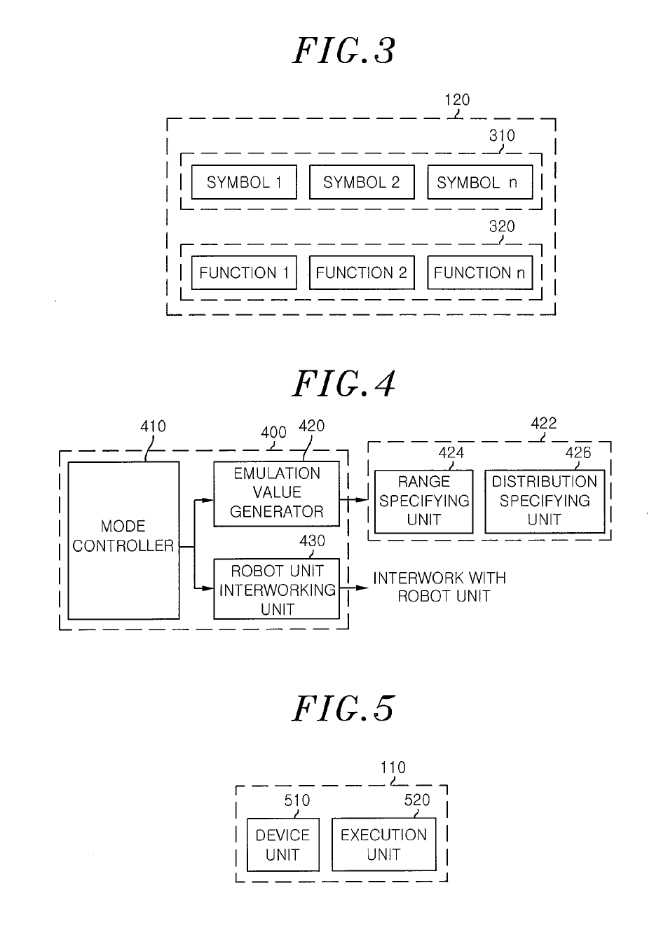

FIG. 3 is a block diagram showing the configuration of the emulation unit shown in FIG. 1.

Referring to FIG. 3, the emulation unit 120 may include the symbol management unit 310 and the function management unit 320, etc.

The symbol management unit 310 may register or delete the symbol in response to a request for the registration and deletion of the symbol from the robot unit 110. In addition, the operating mode for each symbol may be set according to the setting command of the execution mode (real mode, emulation mode) for each symbol. Each of these symbols has a generating unit in which the emulation value of the symbol is generated or the actual value is obtained.

The function management unit 320 may register or delete the function in response to a request for the registration and deletion of the function from the robot unit 110. In addition, the operating mode may be set according to the setting command of the execution mode (real mode, emulation mode) for the function. Each of these functions has a generating unit in which the emulation value corresponding to an execution result of function is generated or the actual result of the execution is obtained.

FIG. 4 is a block diagram showing the configuration of a generating unit included in each symbol and function shown in FIG. 3.

Referring to FIG. 4, the generating unit 400 included in each function or symbol may include a mode controller 410 for setting the real mode or the emulation mode, an emulation value generator 420 for generating the virtual value in the emulation mode, and a robot unit interworking unit 430 for getting the real value from the robot in the real mode.

The mode controller 410 may receive a setting command of the operating mode from the symbol management 310 or the function management 320, the real mode or the emulation mode may be set to the symbol or function based on the received setting command. Further, the mode controller 410 may perform a mode control on the emulation value generator 420 and the robot unit interworking unit 430 based on the set mode.

The emulation value generator 420 has the emulation modeling unit 422 for generating the emulation value, and the emulation modeling unit 422 may include the range specifying unit 424 and distribution specifying unit 426.

The emulation modeling unit 422 may generate a model about a range of the value for the emulation and a probability of the return value of each symbol or function.

The range specifying unit 424 may specify range information of the value for the emulation, and the range may include, e.g., an enumeration, discrete, and continuous range. Here, [1, 3, 5, 7] which specifies a return value of the symbol or the function as a few fixed value may be exemplified as the enumeration range. Further, [1 . . . 7] which specifies the range as integers from 1 to 7 may be exemplified as the discrete range. Furthermore, [1.0, . . . , 7.0] which specifies the ranges as real numbers from 1.0 to 7.0 may be exemplified as the continuous range.

The distribution specifying unit 426 may specify probability information of the return value of each symbol or function, and the probability may include, e.g., a uniform, Gaussian, and discrete distribution. Here, values specified by the range specifying unit 424 have the same probability and are returned as the return value of the symbol or the function in the uniform distribution. Further, values are returned according to a Gaussian probability distribution in the Gaussian distribution. Furthermore, the discrete distribution may be used only in the range of the enumeration, and may return the return value of the symbol or the function depending on the relevant probability after assigning the probability to each enumeration value.

The robot unit interworking unit 430 is required when the execution mode of each symbol or function is set to the real mode, not the emulation mode. At this time, real symbol values or real functions generated in the robot unit 110 need to be performed, thus, it is possible to interwork with the robot unit 110 only when who registered each symbol or function is known to the user. Therefore, the robot interworking unit 430 is required to make the interworking.

As an example of the robot interworking unit 430, when the IP address and port of each robot unit 110 are stored and each symbol or function is executed on the real mode, the return value of the symbol or function may be transmitted to the robotic application, by interworking with the robot unit based on the stored IP address and port of each robot unit 110.

FIG. 5 is a block diagram showing the configuration of a robot unit shown in FIG. 1.

Referring to FIG. 5, the robot unit 110 may include a device unit 510 performing control and access to various devices in the robot, and an execution unit 520 performing various functions or transmitting symbol values or information to the emulation unit 120 in response to a request of the emulation unit 120.

The execution unit 520 may register its own various symbols or functions in the emulation unit 120. In addition, when a request to update the symbol value is received from the emulation unit 120, the execution unit 520 may generate the symbol values to transmit to the emulation unit 120. At this time, the symbol value may be, e.g., the value of a sensor or an actuator that is received by interlocking with the device unit 510, or may be, e.g., the value that a specific algorithm is applied to the sensor or actuator. However, this is an example embodiment and the kind of information included in each symbol may vary depending on embodiments.

Further, the execution unit 520 may execute a function when a request to execute the function is received from the emulation unit 120. At this time, the execution of the function may be, e.g., a function of controlling devices by interlocking with the device unit 510, or a result of applying a specific algorithm (e.g. an algorithm for summing two integers). However, this is an example embodiment and the kind of information include in the execution result of each function may vary depending embodiments.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for performing emulation on a robotic application comprising:
an emulation unit configured to perform emulation on a symbol and function corresponding to a control command of a robotic application;
a robot unit configured to register the symbol and function to the emulation unit, and control a device of a robot; and
a robotic application control unit configured to control the symbol and function of at least one robot by executing the robotic application.

2. The apparatus of claim 1, wherein the emulation unit includes:
a symbol management unit configured to store and delete at least one symbol received from the robot unit, and set an execution mode of the symbol according to a setting command of the execution mode; and
a function management unit configured to store and delete at least one function receive from the robot unit, and set the execution mode of the function according to the setting command of the execution mode.

3. The apparatus of claim 2, wherein the symbol and function includes a generating unit configured to generate an emulation value or interwork with the robot unit according to one of a real mode and an emulation mode.

4. The apparatus of claim 3, wherein the generating unit includes:
a mode controller unit configured to set the real mode or the emulation mode to the symbol or function;
an emulation value generator configured to generate the emulation value for the symbol or function set to the emulation mode based on the predetermined emulation model under the control of the mode controller; and
a robot unit interworking unit configured to receive from the interlocked robot unit the real value for the symbol or function set to the real mode under the control of the mode controller.

5. The apparatus of claim 4, wherein the emulation modeling unit includes:
a range specifying unit configured to set a range for the emulation using one of enumeration range, discrete range, and continuous range; and
a distribution specifying unit configured to set the probability having the return value of the symbol using one of single distribution, Gaussian distribution, and discrete distribution.

6. The apparatus of claim 4, wherein the emulation modeling unit includes:
a range specifying unit configured to set the range for the emulation using one of enumeration range, discrete range, and continuous range; and
a distribution specifying unit configured to set the probability having the return value of the function from one of single distribution, Gaussian distribution, and discrete distribution.

7. The apparatus of claim 4, wherein the robot unit interworking unit interlocks based on pre-stored information of the robot unit, and requests a real value of the symbol or the function set to the real mode from the robot unit.

8. The apparatus of claim 1, wherein the robot unit includes:
a device unit configured to include device information about the robot, and perform controlling and accessing to each device; and
an execution unit configured to transmit and register the information about the symbol and function of the robot, and transmitting an execution result of the symbol and function after controlling and executing the device unit based on a request for updating the symbol value received from the emulation unit and a request for executing the function;

9. The apparatus of claim 1, wherein the robotic application control unit executes the robotic application for controlling the robot unit, and transmits a control command for executing the symbol or the function to the emulation unit.

10. The apparatus of claim 9, wherein the robotic application control unit, when the emulation value about the symbol or the function is received from the emulation unit, configured to transmit a call of the symbol or the function required to be executed according to the emulation value to the emulation unit.

11. A method for performing emulation on a robotic application comprising:
registering a symbol and a function received from a robot unit to the emulation unit;
when a control command is received from the robotic application executed in a robotic application control unit, performing the emulation on the symbol and the function corresponding to the control command; and
transmitting the emulation value to the robotic application control unit.

12. The method of claim 11, wherein said registering a symbol and a function includes:
storing at least one symbol in the symbol management unit or deleting same in response to a request from the robot unit, and setting an execution mode of the symbol according to the setting command of the execution mode; and
storing at least one function in the function management unit or deleting same in response to the request from the robot unit, and setting the execution mode of the function according to the setting command of the execution mode.

13. The method of claim 11, wherein said performing the emulation includes generating the emulation value of each symbol and function according to one of a real mode and an emulation mode through the generating unit or interworking with the robot unit.

14. The method of claim 13, wherein said generating the emulation value or interworking with the robot unit includes:
setting one of the real mode and the emulation mode to the symbol or the function by the mode controller in the generating unit; and
generating the emulation value for the symbol or function set to the emulation mode based on the predetermined emulation model by the emulation value generator under the control of the mode controller.

15. The method of claim 14, wherein the emulation model includes:
a range information which a range for the emulation is set using one of enumeration range, discrete range, and continuous range; and
a distribution information which a probability having the return value of the symbol or function is set using one of single distribution, Gaussian distribution, and discrete distribution.

16. The method of claim 13, wherein said generating the emulation value and interworking with the robot unit includes:
setting one of the real mode and the emulation mode to the symbol or the function by the mode controller in the generating unit; and
receiving a real value for the symbol or function set to the real mode from the robot unit interworking with the robot unit interworking unit under the control of the mode controller;

17. The method of claim 16, wherein said receiving a real value includes:
performing interlocking based on pre-stored information of the robot unit; and
requesting the real value for the symbol or the function set to the real mode from the robot unit.

18. The method of claim 11, further comprising:
transmitting information for the symbol and the function from the robot unit to the emulation unit;
receiving a request for updating a symbol value or executing the function from the emulation unit; and
transmitting an execution result of the symbol or the function by controlling each device in response to the received request.

19. The method of claim 11, wherein said performing the emulation includes receiving the control command for executing the symbol or the function of the robot unit from the robotic application executed by the robotic application control unit.

20. The method of claim 19, wherein said performing the emulation includes transmitting a call of the symbol or the function required to be executed according to the emulation value to the emulation unit by the robotic application control unit that receives the emulation value about the symbol or the function.
